(19) United States
(12) Patent Application Publication
(10) Pub. No.: US 2007/0083817 A1
(43) Pub. Date: Apr. 12, 2007

(54) Input device for a data processing Markus Trauberg Input device for a data processing system

(76) Inventors: Andreas Schmidt, Braunschweig (DE); Markus Trauberg, Velchede (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/571,284

(22) PCT Filed: Aug. 27, 2004
(86) PCT No.: PCT/EP04/51945

§ 371 Date: Mar. 9, 2006

(30) Foreign Application Priority Data
Sep. 9, 2003 (DE) 103 41 580.7

(51) Int. Cl. G06F 3/00

(52) U.S. Cl. 715/762

(57) ABSTRACT

Disclosed is an input device which is used to input control instructions into a data processing system, embodied more particularly in the form of a mobile telephone. The input device comprises a movement capture device used to capture a translator movement of a reference point of the input device and to output movement data. Said device also comprises a display device with a display field for displaying a field of control elements which are respectively allocated at least one specific control instruction. The input device also comprises a control device for controlling the display device in such a way that the field of control elements is displaced in response to the movement data outputted by the movement capture device on the display field. The input device further comprises a selector device for selecting a control element from the field of control elements which is located in a specific selected section of the display field.

### CROSS REFERENCE TO RELATED APPLICATIONS

This application claims priority to the German application No. 10341580.7, filed Sep. 9, 2003, and to the International Application No. PCT/EP2004/051945, filed Aug. 27, 2004 which are incorporated by reference herein in their entirety.

### FIELD OF INVENTION

The present invention relates to an input device for a data processing system allowing convenient input of text or general control instructions.

### BACKGROUND OF INVENTION

The input of text or general control instructions for controlling the mobile telephone plays a significant part in the use of data processing systems such as mobile radio units or mobile telephones. Text input for mobile telephones is currently mainly used when creating short messages to send via SMS (Short Message Service). In addition to the aforementioned Short Message Service, a text input is also required for other services. These include for example a service for sending multimedia messages (Multimedia Messaging Service: MMS), an e-mail service, a service for browsing the (mobile) Internet, for which a reference name (Uniform Resource Locator: URL) or a user name and password must frequently be input. It is also necessary to input characters or letters for managing mobile telephone books, in particular for inputting names and telephone numbers for telephone book entries into the mobile telephone.

### SUMMARY OF INVENTION

In addition to the input of text or numbers and characters, the input of control instructions, in particular when playing games on the mobile telephone, is becoming an increasingly important part of mobile telephone use. For many games a 2D control is required for horizontal and vertical movements, usually in the form of a 2-way rocker switch, the keyboard of the mobile telephone or a mini joystick.

When building or designing modem mobile terminals, such as mobile telephones, developers are now faced with the problem that while, on the one hand, mobile terminals are expected to get smaller and smaller, suitable input devices, such as a keyboard, a joystick etc. must nevertheless still be provided to allow use of the aforementioned services or games.

A user interface for inputting control instructions, in particular numbers and characters, typically comprises a keyboard consisting of a three by four block of keys. The keys host several characters, that is, on one side the numbers “0” to “9” as well as the two special characters, “*” and “#”, while on the other side the letters, for which eight of-the twelve keys are respectively allocated three to four letters. The respective letters or characters can be selected either by pressing a single key several times, or using alternative methods, such as for example, the “T9” input method, which, with the aid of a dictionary, only displays possible words which make sense in the key sequence. The aforementioned options are convenient for the practised user and, for someone with a certain level of experience, also allow texts to be input quickly; however their use should not be regarded as particularly intuitive.

It is therefore an object of the present invention to create an intuitive and convenient way of inputting control instructions into a data processing system with a minimal technical outlay.

This task will be achieved by claims. Advantageous developments are the subject-matter of the dependent claims.

An input device or input unit for inputting control instructions into a data processing system first of all comprises a movement acquisition device for capturing momentary movement of a reference point of the input device (e.g. as explained below, on a base) and for outputting relevant movement data. The movement acquisition device is specially designed for capturing translative movement of the reference point. The input device also comprises a display device or a display with a first display field for displaying a field of control elements which is respectively allocated at least one specific control instruction. The display device can, for example, take the form of a Liquid Crystal Display (LCD) or an electroluminescent display (using organic or inorganic semiconductors or electroluminescent colorings). The first display field may comprise a section of the display device. The input device further comprises a control device for controlling the display device in such a way that t the field of control elements is displaced in response to or in accordance with the movement data outputted by the movement acquisition device on the first display field. Finally, a selector device is used to select a control element from the field of control elements located in a specific selection segment of the first display field. This specific selection segment may be a display segment in the middle of the first display field for example, but it may also be any section marked by a symbol such as an arrow for example. To enable a user to recognize which control element is presently located in the specific selection segment, the appropriate control element can be visibly activated, for example using a distinctive border, by changing the color of the control element, or by setting the control element to flash etc. The selector device comprising a key as selection means in the simplest case scenario for example allows the user to now select the control element in the selection segment, whereupon a control instruction allocated to this control element is carried out or an appropriate signal is output to the data processing device. With an input device, with which control elements on the display device or on the first display field can be displaced on the first display field as a function of the movement of the input device, it is advantageous that, on the one hand, no additional selection means such as a pen are required, but also because no cumbersome, large keys with complex key layouts have to be used. Rather, the input device can be moved in an easy and intuitive manner, particularly when it comes to translative movement, for example parallel to a table top, until the required control element in the specific selection segment on the first display field has been displaced for final selection.

According to an advantageous embodiment, the field of control elements displayed on the first display field takes the form of a virtual keyboard, with which individual keys serving as control elements are allocated one or more characters. For example, the field of control elements may constitute control elements in the form of the keys of a QWERTY keyboard. Since there is a relatively large number of keys on a QWERTY keyboard and it is not possible to have a clear view of all the keys on the first display field, it is advantageous to display only a section of this keyboard on the first display field. The user will then see the keyboard on the first display field as though through a window. In order to reinforce the user's impression that he is looking through a window, it is conceivable that the control device may control the display on the first display field in such a way that the movement of the field of control elements is complementary to the movement captured by the input device. That means, for example, that when the input device is moved to the left, the control element of the field of control elements is displaced to the right. This gives the user the impression that he is looking through the window of the first display field into a fixed view of the field of control elements, which, as mentioned above, may take the form of a keyboard.

It is however also possible for the field of control elements to represent any user surface which features the specific elements or sections behind which there are control instructions or to which control instructions are allocated. Consequently, in addition to a keyboard, the field of control elements may also constitute a menu structure with various symbols or icons arranged on a neutral background which, when selected, can start up respective software applications programs for example. However, the field of control elements may also constitute an interface for a computer game, in which individual control elements are areas which the user must send into a goal, that is, the specific selection segment, by moving the input device, in order to adapt this control element in a particular way as part of the game. By way of example, a control element may take the form of an object, such as a ball, which must have a particular color in the context of the game, so that by sending this ball into the specific selection segment and by selecting the ball, the user can “spray” it with the correct color. In terms of the representation of the field of control elements in the context of a game in particular, control elements can move self-sufficiently or independently around the user interface, so that it may be the task of the user in the game for instance to “catch” this control element by moving the input device.

In order to capture translative movement in particular, but also rotational movement, the movement acquisition device can comprise not only an optical or mechanical sensor but also an acceleration sensor. The mechanical sensor may take the form of a roller sensor for capturing the rolling movement of a ball on an interface. The acceleration sensor may in particular take the form of a longitudinal acceleration sensor for capturing the acceleration of a reference point of the input device, with the movement of the input device or, to be more precise, of the reference point, the speed or position fmally being calculated by temporal integration. The optical sensor can be specially designed for capturing certain patterns in the surroundings for determining the movement of the input device as a function of changes to the captured pattern. While the movement of the input device used to control the display on the first display field should preferably be along a plane which runs parallel to a protracted object such as a table, it is also conceivable, particularly when an acceleration sensor is used, that movements “in open space” may be captured by the input device in order to control the display device in this way or to displace the control elements on the first display element.

According to a further advantageous embodiment, it is also possible for the input device to feature a movement acquisition device, in particular, for capturing rotational movement about an axis extending through the reference point and for outputting relevant (second) movement data to the control device. This means that the control elements of the field of control elements on the first display field can be displaced as a function of the captured rotation. It is thereby also possible again for the control device to control the display on the first display field in such a way that the field of control elements is shown as quasi fixed, with the user viewing the field of control elements on the first display field as through a window. It is therefore possible that when the input device rotates about the reference point to the right, the display or view of the field of control elements on the first display field is rotated about the reference point to the left, thus maintaining the impression that the field of control elements is fixed.

According to a further advantageous embodiment it is conceivable for not only one, but several control instructions to be allocated to one control element o f the field of control elements. It is thus possible for the display device to feature a second display field which is configured so as to display the additional or the totality of those control instructions of the control element, which is located precisely in the selection segment of the first display field. Take again the example of the view of a virtual keyboard through the field of control elements with which several numbers or characters can be allocated to a particular key on the keyboard. For example, a virtual key is allocated both the number “6” and the “&”. In the second display field, representations or representative symbols of these control instructions (in this case for inputting numbers or characters) can now be displayed.

If a second display field for displaying specific or all control instructions allocated to a control element is now available, it is naturally also advantageous if the selector device comprises corresponding means for selecting the corresponding control instruction s. In the simplest case, the selector device can again comprise a key, with the first control instruction being carried out by a short press of the key, whilst the second control instruction is carried out with a long press of the key. It is hereby also conceivable that the first control instruction is carried out by a single press and the second control instruction after short repeated presses. According to an advantageous development, however, the selector device comprises a plurality of selection means, of which one selection means is respectively allocated to a specific control instruction of the control instructions assigned to one control element. It is particularly advantageous if the respective selection means are positioned next to the second display field in such a way that a respective selection means is located next to a representation (e.g. a symbol) of an allocated control instruction. This enables the user of the input device to input characters or text quickly and intuitively, since, not only does he no longer have to search for the required key on a key hosting two or more letters, but he can also select the correct control instruction intuitively by applying the relevant selection means, so -called “soft keys”, in addition to the representations of possible control instructions.

Specially developed for inputting text, the display device comprises a third display field designed to display the most recently selected control instructions. This means that when text is input the most recently selected numbers, characters or symbols will be displayed in the third display field so that the user can view the text as it is written and make quick corrections as required.

According to a further aspect of the invention, a data processing system is created with an input device as described above. The data processing system can, in particular, take the form of a portable data processing system, such as a mobile radio unit or a mobile telephone for example, but also a portable computer such as a PDA (Personal Digital Assistant) or organizer. An input device, though, may also come in the form of a separate module, which is connected to the data processing system via a wireless data link such as a radio circuit or infrared circuit but also a wired circuit.

When the input device is designed as a separate modular component in particular, it can also be used to control any electric device, thereby allowing the input device to cover a wide range of uses.

### BRIEF DESCRIPTION OF THE DRAWING

Preferred embodiments of the present invention are described in further detail below with reference to the appended diagrams, in which;

FIG. 1 shows a side view of a data processing system in the form of a mobile telephone in accordance with a preferred embodiment;

FIG. 2 shows a plan view of the mobile telephone shown in FIG. 1 to indicate how text is input using a virtual keyboard;

FIG. 3 shows a diagram of the display device of the mobile telephone illustrated in FIG. 1 in accordance with a further embodiment;

FIG. 4 shows a plan view of the mobile telephone shown in FIG. 1 to illustrate how the method according to the invention is used in the context of a game.

### DETAILED DESCRIPTION OF INVENTION

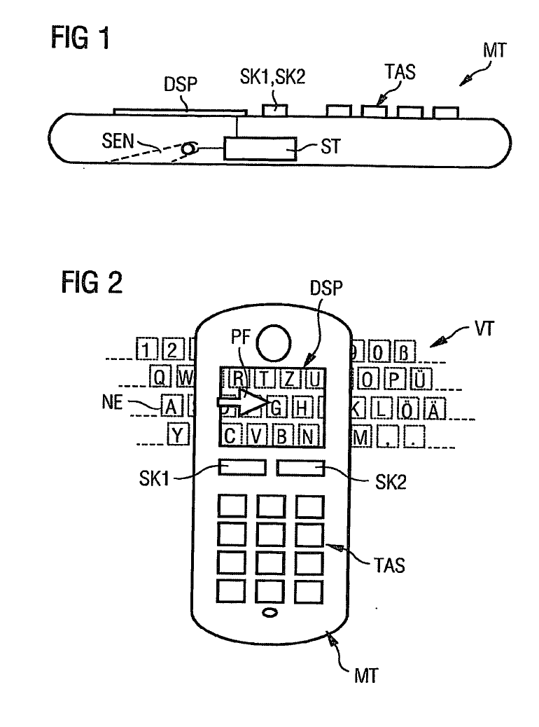

Reference is now made to FIG. 1, in which a data processing system in accordance with a preferred design of the invention is shown. The data processing system takes the form of a mobile telephone MT with a built-in input device in accordance with the embodiment of the invention. Firstly, the mobile telephone features a display device DSP which may take the form of a Liquid Crystal Display, for example. The mobile telephone also comprises the two control keys, SKI and SK2, which are more clearly illustrated in FIG. 2. Below, or in FIG. 1 there is a keyboard TAS next to control keys SKI and SK2 consisting of four rows and three columns of keys. The underside of the mobile telephone MT has a movement acquisition device in the form of an optical sensor designed to capture the translative movement of the mobile telephone MT, or more precisely, of its reference point, such as the tip of the arrow PF in FIG. 2 or cross ZM in FIG. 4, on or across a flat surface such as a table for example. The optical sensor/SEN can capture the grain of a table as a pattern and correspondingly derive a movement of the mobile telephone MT from the movement or change in the pattern, then forward relevant movement data to a control device ST, which will finally control display device DSP.

Reference is now made to FIG. 2, in which a plan view of the mobile telephone MT just mentioned is displayed. As illustrated more clearly in the diagram, mobile telephone MT viewed from top to bottom comprises the display DSP, the two control keys or soft keys SKI and SK2 and the keyboard TAS.

An essential possible use of the present invention is now to input text which can be sent to another mobile telephone by SMS (Short Message Service) or MMS (Multimedia Messaging Service) for example. With the conventional system, this text is input using the keys of the keyboard TAS, with each key being respectively allocated a complex * scheme of several characters which is barely comprehensible, particularly to the unpractised user, and does not allow intuitive text input. According to the present invention, however, text input is easier and more intuitive. With this aim in mind, a display field (or first display field) is provided on the display DSP, on which a field of control elements is arranged in the form of a virtual keyboard VT. This virtual keyboard may, for example, take the form of a conventional QWERTY keyboard. The keyboard will comprise the control device ST described in FIG. 1 and is displayed on the display device DSP. As is clear in the background of the mobile telephone MT, the virtual keyboard VT would comprise four rows of keys which nevertheless will not fit on the rather small display field of a mobile telephone MT if a clear and easy -to-read view is required. In order to achieve this clear view, only a section of the virtual keyboard with the respective keys as control elements is now shown on the display field of the display device DSP. The display field takes the form of a type of window through which the virtual keyboard VT can be viewed. If a user now wishes to input a text using this virtual keyboard VT, for example for a short message, he will now attempt to move the desired key into the display field of the display device DSP, namely into a specific selection segment from which the key can then be selected and an allocated character input. As illustrated in FIG. 2, an arrow PF with its tip marking the specific selection segment serves to indicate the specific selected area. The arrow PF can be provided on a transparent display cover for example, but it can also be integrated in the view on the display field using software. If the PF arrow is not used, it is also possible simply to define the specific selected section in the centre of the display field. It goes without saying that there are also o other suitable ways of marking sections in the display field in order to set these specific selection segments, such as marks in the comer of the display field or other types of marking. As illustrated in the figure, the letter “G” is currently located in the selection segment and represents the active element or control element HE. This active element HE or this element HE at the focal point can be visibly activated for a better contrast between it and non -active elements by highlighting it in bold for example (compare with FIG. 2), by enlarging it, by highlighting it in color or inverting it, putting a border around it, by setting it to flash for a specific period, etc. Should the user now wish to select this active element HE or to input the character allocated to this element for a text, he must select this element or confirm selection of this element. In order to do this, the mobile telephone comprises the SK1 or SK2 keys which can be used as selection means. It is assumed for the current example that the SKI key serves to select or confirm active elements. If the user now presses the SKI key in the condition illustrated in FIG. 2, the character G is input.

Should the user now wish to input another character, he must move or displace the window shown by the display field in relation to the virtual keyboard VT. It is assumed that the user wishes to select a non-active element NE, the element representing the letter “A” for example, in order to input the letter “A” into his text. For this purpose se, he now moves his mobile telephone MT to the left in the figure. This movement is now captured by the optical sensor SEN and the appropriate movement data will now be forwarded to the control device ST. This control device ST is now designed in such a w ay that it controls the display device DSP in such a way that the content of the display field is displaced to complement the captured direction of movement. In the case just described, this means that when a movement of the mobile telephone MT to the left is captured, the display on the display field is displaced to the right. This means that the respective keys of the virtual keyboard VT move from left to right so that the user has the impression that the virtual keyboard is fixed, while only a small “window” section of the virtual keyboard VT can be viewed by moving the mobile telephone.

Should the user wish to input additional characters, he only needs to move the mobile telephone MT in such a way that the desired control element or the key with the desired letter appears in the display field of the display device DSP and, to be more precise, in the specific selection segment, so that this key becomes the active element HE, whereupon the user then needs only confirm this selection using the SKI key in order to input the appropriate letter.

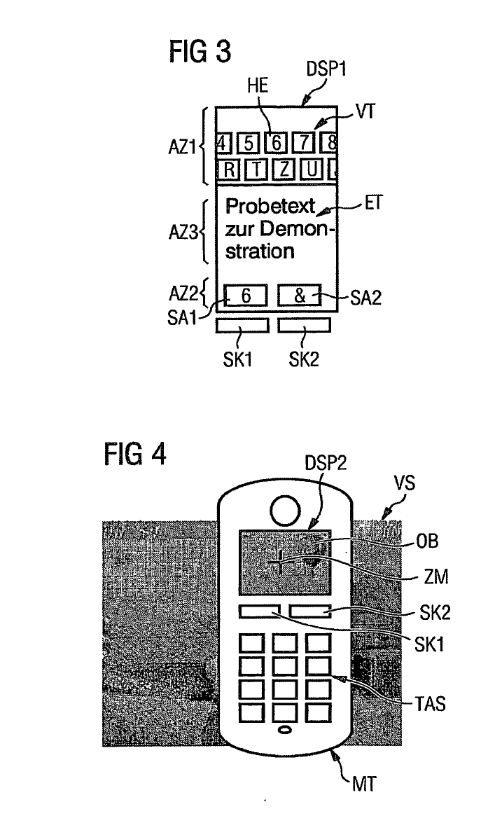

Reference is now made to FIG. 3, in which a display device DSP with a number of display fields for convenient text input is displayed in accordance with an additional design. The display device DSP 1, which can be arranged in the mobile telephone illustrated in FIG. 2 for example, instead of display device DS, comprises a first display field Az1 in which a virtual keyboard VT corresponding to the display field of the display device DSP in FIG. 2 is shown. Due to the now reduced display options however, only two lines of the virtual keyboard are shown in this example, allowing a clear view and easy selection of keys. By way of contrast to the display DSP of FIG. 2, there is no arrow PF to mark out the specific selection segment for display device DSP1 or the first display field AZ 1. Rather in this instance, the specific selection segment is set in the middle of the fir st display field AZ1. The centre of the first display field AZI also serves as a reference point for the mobile telephone MT. As illustrated in FIG. 3, a virtual key is currently located in the specific selection segment which has (visibly) been allocated the number “6”. This virtual key thus represents the active element HE, the control instruction of which can be selected if it is to be carried out. By way of contrast to the embodiment for text input described in FIG. 2, in which one control instruction is allocated to one virtual key, a plurality of control instructions are allocated to one virtual key of the virtual keyboard VT with the design illustrated in FIG. 3. In particular, this should enable a user to use the virtual keyboard like the familiar typewriter keyboard or computer keyboard. With these types of keyboards, one key hosts several control instructions so that when pressing specific control keys, again the “Shift” key together with the actual key, another control instruction can be input as though the respective control key had not been pressed. In the present example illustrated in FIG. 3, the number key “6” should host two control instructions or characters, namely the number “6” and the character “&”. The possible characters offered by the active element HE are displayed in a second display field AZ2, where the first control instruction SAl (or the symbol representing it) in this case the number “6”and the second control instruction SA2 (or the symbol representing it) in this case the character “&”, are shown next to each other on the bottom row of the third display field. Should a user now wish to select or input one of the two characters as text, he only needs to press the control keys next to the respective control instructions S Al and SA2 or soft keys SKl or SK2. This directly adjacent arrangement of the control keys SKI and SK2 under the available control instructions or characters, SAl and SA2, enables the user to use the mobile telephone intuitively, particularly when inputting characters for writing a text.

It should further be noted here that, in particular when inputting letters for which there is the option of upper or lower case, when typing one of these letters (when bringing the letter into the specific selection segment), the upper case letter for example can be displayed as a control instruction SAl, while the lower case letter is displayed as a control instruction SA2. In this way, simple and intuitive use can be achieved, with which a user can bring their knowledge of a conventional-typewriter keyboard or computer keyboard to bear. In particular when using the two control keys or soft keys SKI and SK2, the known “Shift” function of a computer keyboard (changing the input by pressing down the “Shift” key) can be implemented.

In order to make inputting text even more convenient, the display device DSP 1 also comprises a third display field AZ3, in which the most recently inputted control instructions or characters are shown as drafted text ET. The user therefore has an overview of which characters or words he has input recently and can also make corrections if necessary.

A control element or a virtual key can again be brought into the specific selection segment by moving the input device as explained in detail in FIG. 2 for example.

Reference is now made to FIG. 4, in which a mobile telephone MT is again displayed, which largely corresponds to the mobile telephone MT shown in FIG. 2, only in this case, a section of a computer game VS interface is shown on a display DSP2 instead of a virtual keyboard for inputting text. In accordance with the display of the virtual keyboard VT according to the explanation in FIG. 2, a type of window is once again shown on the game interface in the display field of the display device DSP2. The display device DSP2 is controlled in this way by a control device (not shown) such that the game interface or graphics appear as quasi fixed, an effect achieved by displacing the game interface section on the display DSP2 in a way which complements the movement of the mobile telephone. This means that if the mobile telephone is moved to the left, the display or section of the game interface in the display device DSP2 is displaced to the right. In this way, by moving the mobile telephone MT on a level, the user can bring specific objects on the game interface which serve here as control elements (and should be pressed or selected as for the input of control instructions explained above) into the specific selection segment which is marked on the display device DSP2 by the cross ZM. For example, an object OB can be brought to the cross ZM by moving the mobile telephone MT up and to the right so that by then pressing the control key SKI in the context of the present game, a shot can be fired at the object. It is also conceivable that the objects serving as control elements are not fixed on the game interface VS, but are mobile. Skill and fast reflexes are therefore also required for the game if the user is to bring the moving object to the cross by moving the mobile telephone.

A further advantage of the invention is that, since it can be used for any kind of input, the conventional keyboard may be dispensed with altogether as an input device, so it is also possible to develop mobile telephones without keyboards which can be produced cost - effectively and offer greater design freedom than devices without the appropriate input options but with a keyboard.

In summary, it could be said, then, that building ng a movement sensor into an input device or a complete data processing system for capturing the movement of the input device or data processing system as well as for controlling the display in response to the captured movement allows simple and intuitive use, with a minimum of technical expenditure involved in the creation of the input device or data processing system as no additional modes of input such as “Navi keys” or “joysticks” are required.

1.-13. (canceled)

14. An input device for inputting control instructions into a data processing system, comprising:
a movement acquisition device for capturing a translative movement of a reference point on the input device and for outputting corresponding movement data;
a display device having a first display field for displaying a field of control elements, at least one control instruction assigned to each control element;
a control device for controlling the display device such that the field of control elements is displaced on the first display field based on to the movement data output by the movement acquisition device; and
a selector device for selecting a control element from the field of control elements, the selector device located in a selection segment of the first display field.

15. The Input device according to claim 14, wherein the field of control elements is a virtual keyboard, at least one character assigned to each key of the virtual keyboard representing the control elements.

16. The input device according to claim 14, wherein the movement acquisition device comprises an optical, a mechanical or an acceleration sensor.

17. The input device according to claim 16, wherein the movement acquisition device comprises the mechanical sensor, the mechanical sensor being a roller sensor for capturing a rolling movement of a ball on a surface.

18. The input device according to claim 16, wherein the movement acquisition device comprises the acceleration sensor, the acceleration sensor being a longitudinal acceleration sensor for capturing an acceleration of the reference point.

19. The input device according to claim 14, further comprising a further movement acquisition device for capturing a rotation about an axis, the axis passing through the reference point, and for outputting further movement data to the control device.

20. The input device according to claim 14, wherein the display device comprises a second display field for displaying a plurality of control instructions assigned to a control element located in the selection segment.

21. The input device according to claim 20, wherein the selector device comprises a plurality of selection elements, each selection element assigned to one control instruction of the control instructions assigned to the control element located in the selection segment.

22. The input device according to claim 21, wherein the selection elements are positioned adjacent to the second display field such that a selection element is located adjacent to a display of a corresponding control instruction.

23. The input device according to claim 14, wherein the display device comprises a third display field for displaying a plurality of recently selected control instructions.

24. The input device according to claim 14, wherein the control device is configured to controls the display device such that at least one of the control elements of the field of control elements moves independently on the first display field.

25. A data processing system, comprising an input device for inputting control instructions into the data processing system, the input device comprising:
a movement acquisition device for capturing a translative movement of a reference point on the input device and for outputting corresponding movement data;
a display device having a first display field for displaying a field of control elements, at least one control instruction assigned to each control element;
a control device for controlling the display device such that the field of control elements is displaced on the first display field based on to the movement data output by the movement acquisition device; and
a selector device for selecting a control element from the field of control elements, the selector device located in a selection segment of the first display field.

26. The data processing system according to claim 25, wherein the data processing system is a mobile radio unit, a mobile telephone, a portable computer or a wristwatch.
